(19) United States
(12) Patent Application Publication
(10) Pub. No.: US 2005/0156910 A1
(43) Pub. Date: Jul. 21, 2005

(54) Optically controlled screen input aid

(75) Inventor: Christoph Brabec, Erlangen (DE)

Correspondence Address: FISH & RICHARDSON PC, 225 FRANKLIN ST, BOSTON, MA, 02110, US

(73) Assignee: SIEMENS AKTIENGESELLSCHAFT, MUNCHEN (DE)

(21) Appl. No.: 10/505,106

(22) PCT Filed: Feb. 12, 2003
(86) PCT No.: PCT/DE03/00410

(30) Foreign Application Priority Data
Feb. 19, 2002 (DE) 102 06 907.7

(51) Int. Cl. G09G 5/00

(52) U.S. Cl. 345/175

(57) ABSTRACT

The invention relates to an optically controllable screen input aid which is integrated, or can be integrated, into a display unit and essentially consists of semiconductor components which are arranged in a raster.

The invention relates to an optically controllable screen input aid which requires no mechanical interaction.

By developing an organic photoelectronic system, in other words a photoelectronic system which is wholly or at least partially configured from organic polymers, it became possible to develop these in a particularly small, thin, flexible and semitransparent form. Multiple n possibilities for their use thereby result, which were up until now impossible and thus also unknown.

Working with computer screen surfaces requires a local and manual interaction with the aid of the mouse. The use of optical scanners which scan the eye movement and detect a point fixed by the eye eliminates this disadvantage. This method however requires a substantial outlay on equipment and thus a financial outlay.

The object of the present invention is thus to provide a screen input aid which can be used in a simple and reliable manner without the need for any direct manual interaction and which can be mass-produced cost-effectively.

The present invention relates to an optically controllable screen input aid which is integrated, or can be integrated, into a display unit and essentially consists of semiconductor components which are arranged in a raster.

In the context of the present invention screens refer in particular to computer screens. Conventionally used input and/or working aids are in particular what are known as mice and/or keyboards. The invention can thus relate to any kind of interactive media.

Preferably semiconductor components take the form of photosensors and/or photodetectors. The main advantage of this type of screen input aid is that essentially the photosensors and/or photodetectors can be manufactured as semitransparent, since they can be fashioned in a known manner from organic polymers.

The arrangement of the photosensors and/or photodetectors in a raster, which serves to achieve maximum coverage of the surface of a computer, is advantageous for the purpose of attaining the highest possible resolution. This raster can either be integrated directly into the display unit of the screen, or can be advantageously integrated into a transparent film which can then be applied to the screen. This transparent film is advantageously configured in such a way that it can be interactively connected to the computer input.

With the aid of the aforementioned embodiments a semitransparent detector can be produced with screen resolution, which can be placed over a display or integrated into the display itself. In the event that the photodetectors are illuminated, for example by means of a laser pointer, a laser diode or a vertical cavity surface emitting laser (VCSEL), the position on the screen is determined immediately.

A suitable selection system or an appropriate coding triggers an event which is presented on the screen. By way of example, a program can then be selected, or an executable sequence called up, as if by clicking with the mouse button. The transmission of a ‘code’ for selecting or activating can be effected via electromagnetic radiation, thus optically, or via microwaves.

The advantage of the inventive screen input aid is based on the use of semitransparent photosensors/photodetectors as an input aid, which is integrated or can be integrated into a display and which allows pixel-specific selection of screen elements but requires no mechanical interaction.

The optically controllable screen input aid according to the invention is thus suitable for use in conjunction with a remote control and in particular as a screen input aid for disabled people for whom manual activation is not possible.

1. Optically controllable screen input aid which is integrated, or can be integrated, into a display unit and essentially consists of semiconductor components which are arranged in a raster.

2. Optically controllable screen input aid according to claim 1, characterized in that the semiconductor components are photodetectors.

3. Optically controllable screen input aid according to claim 1, characterized in that the photodetectors are semitransparent.

4. Optically controllable screen input aid according to claim 2, characterized in that the photodetector is fashioned at least partially from organic polymers.

5. Optically controllable screen input aid according to claim 1, characterized in that the raster of photodetectors achieves screen resolution.

6. Optically controllable screen input aid according to claim 5, characterized in that the raster of photodetectors is an integral component of a transparent film.

7. Optically controllable screen input aid according to claim 6, characterized in that the transparent film can be interactively connected to a computer input.

8. An optically controllable screen input aid according to claim 1 in conjunction with a remote control.

9. Optically controllable screen input aid according to claim 2, characterized in that the photodetectors are semitransparent.

10. Optically controllable screen input aid according to claim 3, characterized in that the photodetector is fashioned at least partially from organic polymers.
